(19) United States
(12) Patent Application Publication
(10) Pub. No.: US 2007/0126999 A1
(43) Pub. Date: Jun. 7, 2007

(54) Apparatus and method for containing immersion liquid in immersion lithography

(75) Inventors: Alex Ka Tim Poon, San Ramon, CA (US); Leonard Wai Fung Kho, San Francisco, CA (US); Gaurav Keswani, Fremont, CA (US)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/601,771

(22) Filed: Nov. 20, 2006

Related U.S. Application Data
(60) Provisional application No. 60/742,885, filed on Dec. 7, 2005.

(51) Int. Cl. G03B 27/52

(52) U.S. Cl. 355/30; 355/53

(57) ABSTRACT

Immersion liquid is contained in the immersion area located between the last optical member of a projection system and a surface that is the subject of exposure by providing a liquid seal located adjacent to the immersion area. The liquid seal extends between the surface to be exposed and a seal-holding-surface located adjacent to the immersion area. The liquid seal is a seal-forming-liquid that is different from the immersion liquid and that is maintained in place between the surface to be exposed and the seal-holding-surface only by surface tension.

### CROSS-REFERENCE TO RELATED APPLICATION

This application claims the benefit of U.S. Provisional Patent Application No. 60/742,885 filed Dec. 7, 2005, the disclosure of which is incorporated herein by reference in its entirety.

### BACKGROUND

Aspects of this invention relate to containing immersion liquid in immersion lithography apparatus and methods.

Lithography exposure apparatus are commonly used to transfer images from a reticle onto a semiconductor wafer during semiconductor processing. A typical exposure apparatus includes an illumination source, a reticle stage assembly that positions a reticle containing one or more patterns, a projection system, a wafer stage assembly that positions a semiconductor wafer, and a measurement system that precisely monitors the positions of the reticle and the wafer. As is known, lithography exposure apparatus also can be used to form images on substrates other than semiconductor wafers, for example, glass or quartz substrates in order to form, for example, flat panel displays such as LCD displays.

Immersion lithography is a technique that can enhance the resolution of lithography exposure apparatus by permitting exposure to take place with a numerical aperture (NA) that is greater than the NA that can be achieved in conventional“dry” lithography exposure apparatus. By filling the space between the final optical element of the projection system and the resist-coated target (wafer or other substrate) with immersion liquid, immersion lithography permits exposure with light that would otherwise be internally reflected at an optic-air interface. Numerical apertures as high as the index of the immersion fluid (or of the resist or lens material, whichever is least) are possible in immersion lithography systems. Liquid immersion also increases the wafer depth-of-focus, that is, the tolerable error in the vertical position of the wafer, by the index of the immersion fluid compared to a dry system having the same numerical aperture. Immersion lithography thus has the potential to improve resolution enhancement equivalent to a shift from 193 nm to 157 nm without actually decreasing the exposure light wavelength. Thus, unlike a shift in the exposure light wavelength, the use of immersion would not require the development of new light sources, optical materials (for the illumination and projection systems) or coatings, and should allow the use of the same or similar resists as conventional“dry” lithography at the same wavelength. In an immersion system in which only the final optical element of the projection system and its housing and the wafer (and perhaps portions of the stage as well) are in contact with the immersion fluid, much of the technology and design developed for dry lithography can carry over directly to immersion lithography.

It is highly desirable to contain the immersion liquid in the vicinity of the gap between the projection optical system and the substrate. However, when the lithography system is a scanning exposure lithography system in which the substrate is moved relative to the projection system, the area of the substrate over which the immersion liquid is contained changes as the substrate moves, which can leave droplets or films of the immersion liquid on the substrate.

A number of problems can arise due to immersion liquid droplets or films being left on the substrate. The droplets or films can perturb the fluid if movement of the substrate carriers such droplets or films into the immersion fluid that is maintained between the projection optical system and substrate, creating bubbles in the fluid, or creating more droplets or films. Fluid evaporating from the substrate can cause thermal problems because of the large heat of vaporization of such fluid. Because it is desirable to maintain the atmosphere around the substrate at a relatively constant temperature and humidity, vaporization of any droplets or films remaining on the substrate is undesirable. Any vapor caused by the evaporated liquid can affect the refractive index of air in the lithography tool chamber, causing stage interferometer errors, for example. In addition, film, droplets, bubbles or vapor may affect autofocus operation.

Efforts have been made to design the liquid supply system (for example, the liquid supply and removal nozzles) so as to contain the immersion liquid in the gap below the projection optical system. However, as substrate stage speeds increase, an instability arises, particularly for photoresists having low contact angles with the immersion liquid. Thus, the spreading of the immersion liquid from the area below the projection lens may occur at high substrate speeds and/or with low contact angle photoresists. Furthermore, if a fluid other than water is used as the immersion liquid, it may become more difficult to contain such fluid. It is thus desirable to provide a separate way of containing the immersion liquid in the area where exposure takes place between the projection optical system and the substrate.

A wiper or“squeegee” surrounding the gap area or merely providing a barrier in the scanning direction might be effective in containing the immersion liquid. However, no solid structure is permitted to contact the substrate because it would scratch and otherwise adversely affect the photoresist and other materials on the substrate.

WO 2004/090634 provides a fluid barrier that can surround the projection system so as to maintain the immersion liquid in the area between the projection system and substrate using liquid and/or gas to create the fluid barrier that contains the immersion liquid. The disclosure of WO 2004/090634 is incorporated herein by reference in its entirety.

WO 2004/093159 discloses providing a ferromagnetic powder in the immersion fluid to improve the magnetic responsiveness of the immersion fluid and then applying a magnetostatic force to an area surrounding the projection system to increase the viscosity of the immersion fluid around the area between the projection optical system and the substrate so as to assist in containing the immersion liquid. The disclosure of WO 2004/093159 is incorporated herein by reference in its entirety.

### SUMMARY

According to aspects of the invention, immersion liquid is contained in the immersion area located between the last optical member of a projection system and a surface that is the subject of exposure by providing a liquid seal located adjacent to the immersion area. The liquid seal extends between the surface to be exposed and a seal-holding-surface located adjacent to the immersion area. The liquid seal is a seal-forming-liquid that is different from the immersion liquid and that is maintained in place between the surface to be exposed and the seal-holding-surface only by surface tension.

According to preferred embodiments, the seal-forming-liquid has a surface tension that is higher than a surface tension of the immersion liquid. According to preferred embodiments, the surface tension of the seal-forming-liquid is at least twice the surface tension of the immersion liquid with respect to the surface to be exposed.

Preferably, the seal-forming-liquid is immiscible with respect to the immersion liquid.

According to some embodiments, the seal-forming-liquid is a liquid metal or a liquid alloy. One preferred liquid metal is mercury. For example, when the immersion liquid is water, mercury is a suitable material for use as the seal-forming-liquid.

According to preferred embodiments, the liquid seal completely surrounds the immersion area.

According to some embodiments, the seal-holding-surface can include protrusions that assist in holding the seal-forming-liquid in place relative to the seal-holding-surface. According to some embodiments, the seal-holding-surface (and its protrusions if they are provided) is disposed on a housing of the projection optical system of the immersion lithography apparatus.

Other aspects of the invention relate to an immersion lithography apparatus incorporating the liquid seal and methods of containing immersion liquid using the liquid seal.

### BRIEF DESCRIPTION OF THE DRAWINGS

The invention will be described in conjunction with the following drawings of exemplary embodiments in which like reference numerals designate like elements, and in which:

FIG. 1 is a simplified elevational view schematically illustrating an immersion lithography system according to an embodiment of the invention;

FIG. 2 is a side view of a liquid seal according to one embodiment of the invention;

FIG. 3 is a side view of a liquid seal according to another embodiment of the invention;

FIG. 4A is a flowchart that outlines a process for manufacturing a device in accordance with aspects of the invention; and

FIG. 4B is a flowchart that outlines device processing in more detail.

### DETAILED DESCRIPTION OF EMBODIMENTS

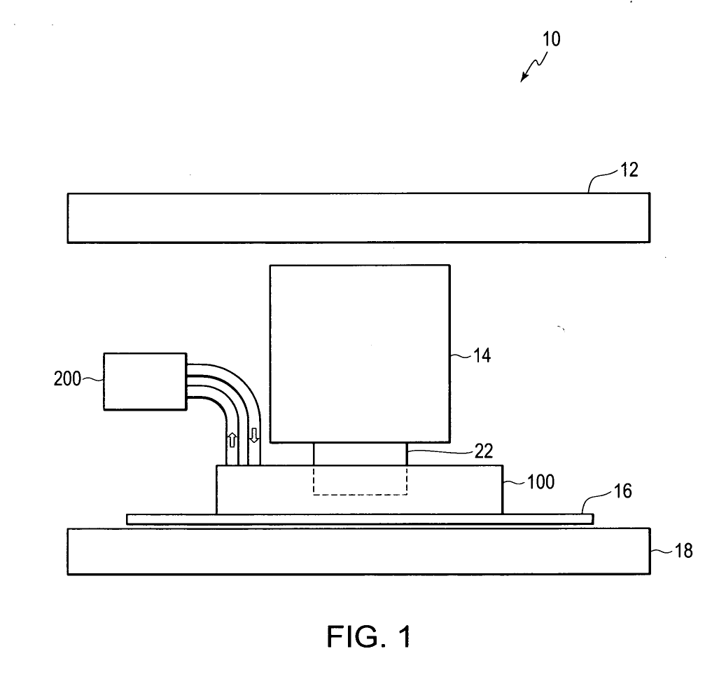

FIG. 1 shows an immersion lithography system 10 including a reticle stage 12 on which a reticle is supported, a projection system 14, and a wafer 16 supported on a wafer stage 18. An immersion fluid supply and recovery apparatus 100, which is sometimes referred to herein as an immersion fluid supply and recovery nozzle, is disposed around the final optical element 22 of the projection system 14 so as to provide and recover an immersion fluid, which may be a liquid such as, for example, water between the final optical element 22 and the wafer 16. The fluid supply and recovery apparatus 100 includes a liquid supply and recovery system 200 that supplies liquid to and collects liquid from the immersion area that is disposed in a gap between the final optical element 22 and the wafer 16. In the present embodiment, the immersion lithography system 10 is a scanning lithography system in which the reticle and the wafer 16 are moved synchronously in respective scanning directions during a scanning exposure operation.

The illumination source of the lithography system can be a light source such as, for example, a mercury g-line source (436 nm) or i-line source (365 nm), a KrF excimer laser (248 nm), an ArF excimer laser (193 nm) or a F₂ laser (157 nm). The projection system 14 projects and/or focuses the light passing through the reticle onto the wafer 16. Depending upon the design of the exposure apparatus, the projection system 14 can magnify or reduce the image illuminated on the reticle. It also could be a 1× magnification-system.

When far ultra-violet radiation such as from the excimer laser is used, glass materials such as quartz and fluorite that transmit far ultra-violet rays can be used in the projection system 14. The projection system 14 can be catadioptric, refractive or completely reflective.

With an exposure device that employs radiation of wavelength 200 nm or lower, use of the catadioptric type optical system can be considered. Examples of the catadioptric type of optical system are shown in U.S. Pat. No. 5,668,672 and U.S. Pat. No. 5,835,275. In these cases, the reflecting optical device can be a catadioptric optical system incorporating a beam splitter and concave mirror. U.S. Pat. No. 5,689,377 also uses a reflecting-refracting type of optical system incorporating a concave mirror, etc., but without a beam splitter, and can also be employed with this invention. The disclosures of the above-mentioned U.S. patents are incorporated herein by reference in their entireties.

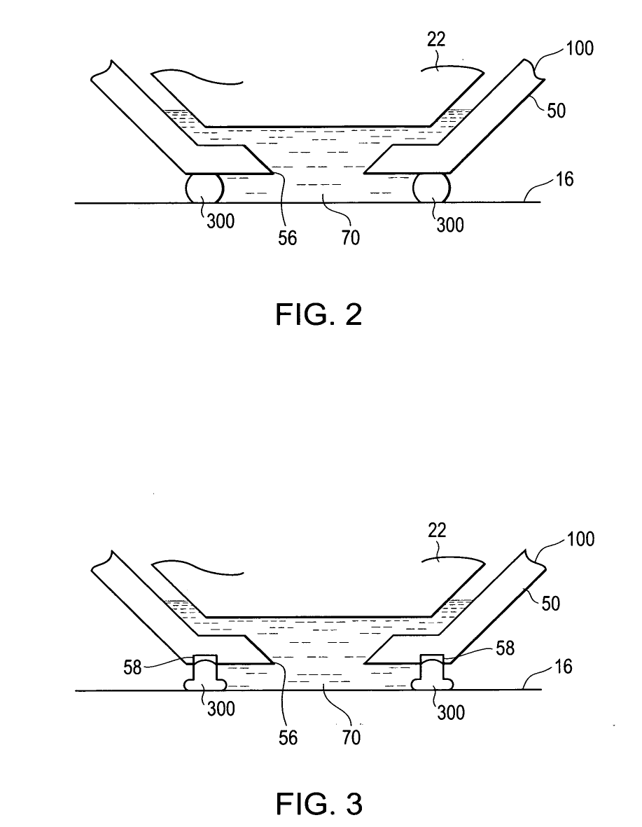

As can be appreciated from FIGS. 1 and 2, the nozzle 100 encircles the final optical element 22 of the projection system 14. Because the illustrated embodiment is a scanning exposure apparatus in which the reticle and the substrate are synchronously moved relative to the projection system 14 during exposure, a generally slit-shaped irradiation area is projected through the reticle, projection system 14 and onto the substrate 16. Accordingly, the lower portion of a housing 50 of the nozzle 100 includes a slit-shaped (or rectangular) opening 56. The irradiation beam passes through the opening 56 during exposure. The immersion area is formed in the gap between the final optical element 22 of the projection system 14 and the upper surface of the substrate (e.g., wafer 16) that is the object of exposure. The immersion area is also formed in the gap between the lower surface of the nozzle 100 and the upper surface of the substrate 16. The immersion area generally is located in the area of the opening 56 and the area surrounding the opening 56 between the opening and the inner perimeter of the liquid seal 300 to be described in more detail below. As described below, immersion liquid 70 such as water is supplied through the housing 50 to the immersion area and is maintained in the immersion area during exposure. As the substrate 16 moves below the projection system 14 and nozzle 100, the liquid seal 300 that surrounds the immersion area prevents immersion liquid 70 from escaping from the area below the housing 50 of nozzle 100.

The distance between the lower surface of the housing 50 and the upper surface of the wafer (or other substrate) 16 is about 0.05-2 nm. Thus, a liquid seal 300 that surrounds the immersion liquid 70 in the immersion area can be used to contain the immersion liquid 70 if the liquid forming the liquid seal 300 has suitable properties. Suitable properties for the liquid that forms the liquid seal 300 are: (i) that it be immiscible with the immersion liquid 70; and (ii) that it have a surface tension that is higher than the surface tension of the immersion liquid 70. The surface tension of the material for the liquid seal 300 should be sufficiently high that it will remain between the lower surface of the housing 50 and the upper surface of the substrate 16 as the substrate 16 moves below the housing 50 and associated projection optical system 14. The lower surface of the housing 50 thus defines a seal-holding-surface that holds the liquid seal 300 in place so as to contain the immersion liquid 70 in the immersion area.

When the immersion liquid 70 is water, liquid metals and/or liquid alloys can be used as the material for the liquid seal 300. For example, mercury can be used to form the liquid seal 300 when water is the immersion liquid 70.

In addition, if liquids having a surface tension lower than water are used as the immersion liquid 70, it is possible that water could be used to form the liquid seal 300.

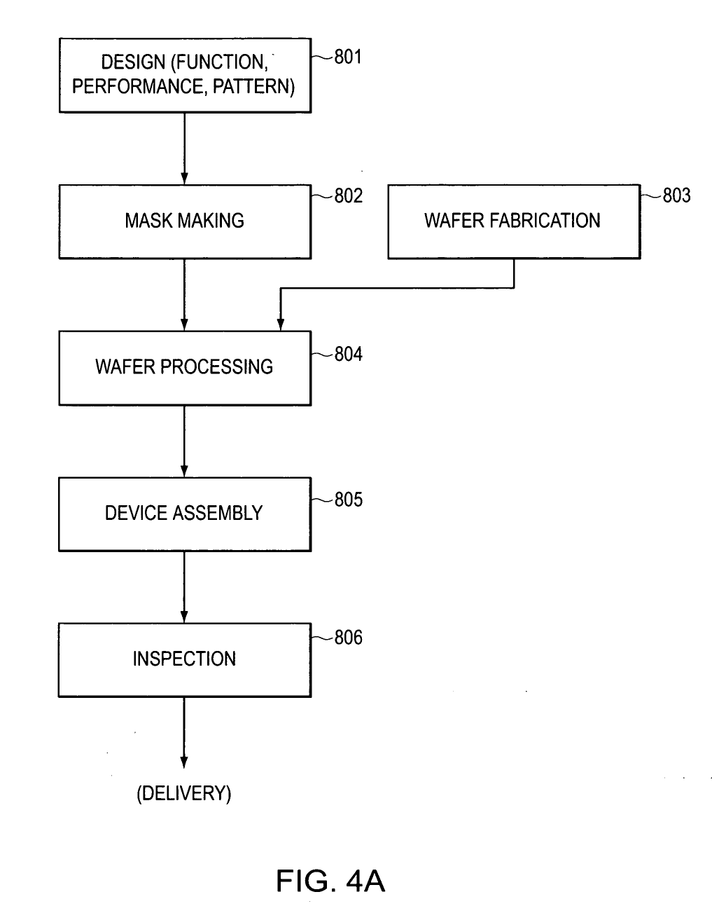

FIG. 3 shows an embodiment in which protrusions 58 are provided on the lower surface (seal-holding-surface) of the housing 50 in order to further hold the liquid seal 300 in place relative to the housing 50. In the FIG. 3 embodiment, the protrusions are two annular ring-shaped protrusions, one having a larger diameter than the other (so that they are coaxial rings), that function to hold the liquid seal 300 between the two annular ring-shaped protrusions.

The liquid seal 300 could be provided instead of other types of containment seals (for example, instead of an air curtain type of seal) known to be provided in immersion lithography apparatus, as shown in FIGS. 2 and 3. Alternatively, the liquid seal 300 could be provided in addition to existing containment seals (for example, in addition to an air curtain type of seal), and would be disposed radially outside of the existing containment seal(s).

There are a number of different types of lithographic apparatus, and although the illustrated embodiment is a scanning exposure apparatus, the invention also can be used with step-and-repeat type photolithography apparatus that expose the pattern from the reticle onto the substrate while the reticle and the substrate are stationary. In the step and repeat process, the substrate is in a constant position relative to the reticle and the projection system during the exposure of an individual field (shot area). Subsequently, between consecutive exposure steps, the substrate is consecutively moved with a substrate stage assembly perpendicularly to the optical axis of the projection system so that the next shot area of the substrate is brought into position relative to the projection system and the reticle for exposure. Following this process, the images on the reticle are sequentially exposed onto the shot areas of the substrate, and then the next shot area of the substrate is brought into position relative to the projection system and the reticle.

The use of the exposure apparatus described herein is not limited to a photolithography system for semiconductor manufacturing. The exposure apparatus, for example, can be used as an LCD photolithography system that exposes a liquid crystal display device pattern onto a rectangular glass plate or a photolithography system for manufacturing a thin film magnetic head.

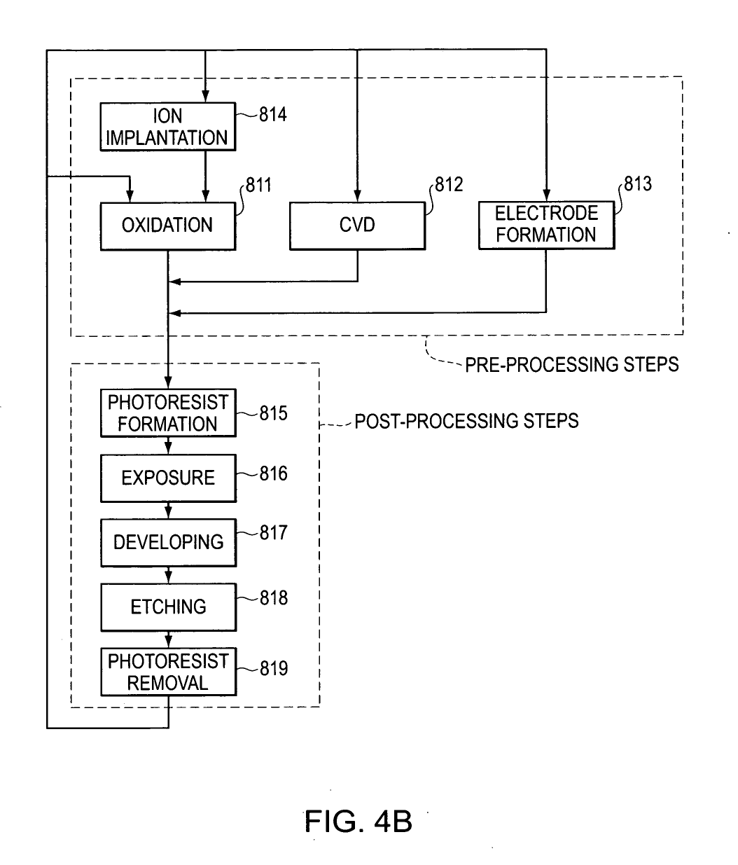

Semiconductor devices can be fabricated using the above described systems, by the process shown generally in FIG. 4A. In step 801 the device's function and performance characteristics are designed. Next, in step 802, a mask (reticle) having a pattern is designed according to the previous designing step, and in a step 803 a wafer is made from a silicon material. The mask pattern designed in step 802 is exposed onto the wafer from step 803 in step 804 by a photolithography system described hereinabove in accordance with the invention. In step 805 the semiconductor device is assembled (including the dicing process, bonding process and packaging process). Finally, the device is then inspected in step 806.

FIG. 4B illustrates a detailed flowchart example of the above-mentioned step 804 in the case of fabricating semiconductor devices. In FIG. 4B, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

A photolithography system (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes providing mechanical interfaces, electrical circuit wiring connections and air pressure plumbing connections between each subsystem. Each subsystem also is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. A liquid containment system for immersion lithography in which a portion of a surface located in an immersion area is exposed to irradiation while immersion liquid is supplied to a gap disposed between an optical member and the portion of the surface located in the immersion area, the liquid containment system comprising:
a liquid seal located adjacent to the immersion area, the liquid seal extending between the surface and a seal-holding-surface located adjacent to the immersion area, the liquid seal is a seal-forming-liquid that is different from the immersion liquid and that is maintained in place between the surface and the seal-holding-surface only by surface tension.

2. The liquid containment system of claim 1, wherein the seal-forming-liquid has a surface tension that is higher than a surface tension of the immersion fluid.

3. The liquid containment system of claim 2, wherein the surface-tension of the seal-forming-liquid is at least twice the surface tension of the immersion liquid.

4. The liquid containment system of claim 1, wherein the seal-forming-liquid is immiscible with respect to the immersion liquid.

5. The liquid containment system of claim 1, wherein the seal-forming-liquid is a liquid metal or a liquid alloy.

6. The liquid containment system of claim 5, wherein the seal-forming-liquid is mercury.

7. The liquid containment system of claim 1, wherein the liquid seal completely surrounds the immersion area.

8. The liquid containment system of claim 1, wherein the seal-holding-surface includes protrusions that assist in holding the seal-forming-liquid in place relative to the seal-holding-surface.

9. An immersion lithography apparatus for transferring an image to a substrate, the apparatus comprising:
a projection optical system that projects the image onto the substrate;
a substrate stage that holds the substrate;
an immersion liquid supply system that supplies an immersion liquid to a portion of a surface of the substrate located in an immersion area that is between the substrate and a last optical element of the projection optical system; and
a liquid seal located adjacent to the immersion area, the liquid seal extending between the surface of the substrate and a seal-holding-surface located adjacent to the immersion area, the liquid seal is a seal-forming-liquid that is different from the immersion liquid and that is maintained in place between the surface of the substrate and the seal-holding-surface only by surface tension.

10. The immersion lithography apparatus of claim 9, wherein the seal-forming-liquid has a surface tension that is higher than a surface tension of the immersion fluid.

11. The immersion lithography apparatus of claim 10, wherein the surface tension of the seal-forming-liquid is at least twice the surface tension of the immersion liquid.

12. The immersion lithography apparatus of claim 9, wherein the seal-forming-liquid is immiscible with respect to the immersion liquid.

13. The immersion lithography apparatus of claim 9, wherein the seal-forming-liquid is a liquid metal or a liquid alloy.

14. The immersion lithography apparatus of claim 13, wherein the seal-forming-liquid is mercury.

15. The immersion lithography apparatus of claim 9, wherein the liquid seal completely surrounds the immersion area.

16. The immersion lithography apparatus of claim 9, wherein the seal-holding-surface includes protrusions that assist in holding the seal-forming-liquid in place relative to the seal-holding-surface.

17. The immersion lithography apparatus of claim 9, wherein the seal-holding-surface is disposed on a portion of a housing of the projection optical system.

18. A method of containing immersion liquid in an immersion area during an immersion lithography process in which a portion of a surface located in the immersion area is exposed to irradiation while the immersion liquid is supplied to a gap disposed between an optical member and the portion of the surface located in the immersion area, the method comprising:
providing a liquid seal adjacent to the immersion area, the liquid seal extending between the surface and a seal-holding-surface located adjacent to the immersion area, the liquid seal being a seal-forming-liquid that is different from the immersion liquid and that is maintained in place between the surface and the seal-holding-surface only by surface tension.

19. The method of claim 18, wherein the seal-forming-liquid has a surface tension that is higher than a surface tension of the immersion fluid.

20. The method of claim 19, wherein the surface tension of the seal-forming-liquid is at least twice the surface tension of the immersion liquid.

21. The method of claim 18, wherein the seal-forming-liquid is immiscible with respect to the immersion liquid.

22. The method of claim 18, wherein the seal-forming-liquid is a liquid metal or a liquid alloy.

23. The method of claim 22, wherein the seal-forming-liquid is mercury.

24. The method of claim 18, wherein the liquid seal completely surrounds the immersion area.

25. The method of claim 18, wherein the seal-holding-surface includes protrusions that assist in holding the seal-forming-liquid in place relative to the seal-holding-surface.
